(19) United States
(12) Patent Application Publication
(10) Pub. No.: US 2009/0194582 A1
(43) Pub. Date: Aug. 6, 2009

(54) METHOD AND SYSTEM FOR RECHARGING

(75) Inventor: Jing YE, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/332,982

(22) Filed: Dec. 11, 2008

(30) Foreign Application Priority Data
Feb. 1, 2008 (CN) 200810057440.5

(51) Int. Cl. G06F 17/00

(52) U.S. Cl. 235/375

(57) ABSTRACT

The present embodiments relate to a recharging method and a recharging system. The recharging method includes: receiving a request including a recharge card ID; judging whether the recharge card is valid, according to the associated information of received recharge card ID and the mobile terminal ID. The method and system for recharging prevent one recharge card from recharging the same or different mobile terminal repeatedly and ensures one recharge card to recharge successfully only once.

### CROSS-REFERENCE TO RELATED APPLICATIONS

This application claims priority to Chinese Patent Application No. 200810057440.5, filed Feb. 1, 2008, entitled “Method and System for Recharging,” the contents of which is hereby incorporated by reference in its entirety.

### TECHNICAL FIELD

The present invention relates to the field of mobile communication technologies, and in particular, to a method and system for recharging user accounts.

### BACKGROUND

Before using a telecom service, a telecom user needs to set up an account in the telecom system. The account is adapted to settle the expenses for the telecom services between the Service Provider (SP) and the telecom user. In the following texts, the word “user” refers to a telecom user; “account” refers to an account set up by the telecom user in the operator's system; and “service” refers to a telecom service. Depending on whether the settlement between the operator and the user is performed before or after the service consumption, users are categorized into Pre-Paid Service (PPS) users and Post-Usage Billing (PUB) users. A PPS user needs to deposit a certain amount of balance into the account before using a service; after the account balance runs out, the PPS user cannot continue using the service until the user deposits a balance into the account again. A PUB user can use the service of the operator before settlement. At the end of each accounting period (a period of settlement between the operator and the user, for example, one month), the operator sends a bill to the user, notifying the PUB user to pay for the services consumed in the accounting period. The PUB user deposits a balance into the account with the operator, and the operator finishes settling the communication expenses.

The user can dial a special number (also known as access number) provided by the operator to replenish the account with more money, which is called “recharging.” A system provided by the operator for implementing the recharging process is called a “recharging system.” The recharging system includes one or more Voucher Centers (VCs), a Mobile Switching Center (MSC)/Service Switching Point (SSP), and a Service Control Point (SCP). A VC stores a recharge card record of a certain par value. When the user recharges the account, the recharging system deposits a sum corresponding to the par value of the recharge card into the user's account. Each recharge card is identified by a password. To recharge the account, the user needs to provide the password of the recharge card. Each recharge card corresponds to a state that identifies whether the recharge card is valid. A valid recharge card refers to an intact recharge card which can be used for recharging; an invalid recharge card refers to a used or expired recharge card which cannot be used for recharging.

In a recharging process under the related art, the SCP communicates with the VC twice. The first communication is to query the recharge card state and check whether the recharge card is valid; the second communication is to set the recharge card to the invalid state. When the recharging process begins, after the first communication is completed, the SCP deposits the sum stated on the valid recharge card into the user's account, and sets a timing lock. The recharge card cannot be used for recharging other accounts within the time limit set by the timing lock. Afterward, the second communication occurs. If the recharge card is not set (namely, the recharge card state is not set to invalid) within the time limit set by the timing lock, the timing lock will become invalid, and the SCP will still return a recharging success response. However, since this recharge card has not been set successfully, that is, the recharge card is still valid and can be used for further recharging, and one recharge card can be used for recharging repeatedly.

### SUMMARY

The embodiments of the present invention provide a recharging method and a recharging system to prevent one recharge card from recharging repeatedly, and control one recharge card to recharge successfully only once.

A recharging method provided in an embodiment of the invention includes: receiving a request including a recharge card ID; judging whether the recharge card is valid according to the associated information of received recharge card ID and the mobile terminal ID.

A recharging method provided in an embodiment of the invention includes: receiving a recharging request message of a mobile terminal; judging whether the information of unsuccessful setting of the recharge card state including the received recharge card ID and the corresponding mobile terminal ID, according to received recharge card ID; and if such information exists, returning a recharge card failure message.

In the embodiments of the present invention, the method judges whether any information about unsuccessful setting of the recharge card corresponding to the mobile terminal exists according to the received recharge card ID. If such information exists, it indicates that the recharge card has been used for recharging a mobile number. This prevents one recharge card from recharging the same mobile terminal repeatedly and ensures one recharge card to recharge successfully only once.

Another recharging method provided in an embodiment of the invention includes: querying a recharge card state according to a recharge card ID carried in a request of querying the state of the recharge card of a mobile terminal; judging whether the recharge card is associated with another mobile number when the state of the recharge card is valid; if associated, returning a recharge card state response indicating that the recharge card is locked.

In the embodiments of the present invention, the method judges whether the recharge card is associated with another mobile number when the recharge card is invalid. If associated, it indicates that the recharge card has been used for recharging another mobile number, and the system will return a recharge card state response message which indicates that the recharge card is locked and the recharging for the mobile user is not allowed. Thereby, this prevents one recharge card from recharging different mobile terminals repeatedly and ensures one recharge card to recharge successfully only once.

An apparatus for recharging provided in an embodiment of the invention includes: a judging module, adapted to receive a request including a recharge card ID; a response module, adapted to judge whether the recharge card is valid according to the associated information of received recharge card ID and the mobile terminal ID.

A Service Control Point provided in an embodiment of the invention includes: a first judging module, adapted to receive a recharging request message of a mobile terminal, and judge whether the information of unsuccessful setting of the recharge card state, including the received recharge card ID and the corresponding mobile terminal ID, according to received recharge card ID; and a first response module, adapted to return a recharge card failure message to the mobile terminal when the first judging module determines that the associated information of unsuccessful setting of the recharge card state corresponding to the mobile terminal exists.

A Voucher Center provided in an embodiment of the invention includes: a second querying module, adapted to query a recharge card state according to a recharge card ID carried in a request of querying the state of the recharge card of a mobile terminal received from the SCP; a second judging module, adapted to judge whether the recharge card is associated with another mobile number when the second querying module finds out that the recharge card is valid; and a second response module, adapted to return a recharge card state response to the SCP, indicating that the recharge card is locked when the second judging module determines that the recharge card is associated with another mobile number.

The embodiments of the present invention will be described in detail hereinafter with accompanying drawings.

### BRIEF DESCRIPTION OF THE DRAWINGS

FIG. 1 is the flowchart of a recharging method, according to an embodiment of the invention;

FIG. 2 is the architecture diagram of a recharging system, according to an embodiment of the invention;

FIG. 3 is the flowchart of another recharging method, according to an embodiment of the invention; and

FIG. 4 is the architecture diagram of another recharging system, according to an embodiment of the invention.

### DETAILED DESCRIPTION OF THE EMBODIMENTS

A recharging method provided in an embodiment of the invention includes: receiving a request including a recharge card ID; judging whether the recharge card is valid according to the associated information of received recharge card ID and the mobile terminal ID. The method may be implemented at the SCP side or/and the VC side and will be described in greater detail below.

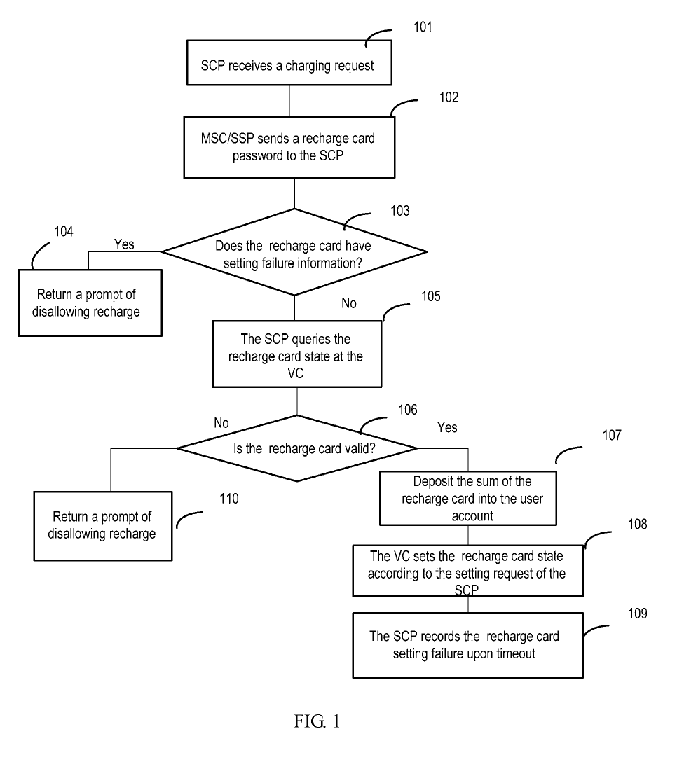

FIG. 1 is the flowchart of a recharging method, according to an embodiment of the invention. This embodiment prevents one recharge card from recharging the same mobile number repeatedly at the SCP side, and includes the following steps.

Step 101: The SCP receives a recharging request of a mobile terminal from the MSC/SSP.

A mobile user dials a service access number to originate a call request to the MSC/SSP, and the MSC/SSP triggers the service to the SCP according to the service access number.

Step 102: The SCP returns to the MSC/SSP a message of playing a voice announcement to the mobile user, to prompt the mobile user to input the recharge card password which identifies the recharge card.

The MSC/SSP plays a voice announcement to the mobile user to obtain the recharge card password, and sends the recharge card password to the SCP.

Step 103: According to the recharge card password, the SCP judges whether the associated information of unsuccessful setting of the recharge card corresponding to the mobile terminal exists, and, if such information exists, the procedure goes to step 104; or else Step 105.

The associated information therein includes the recharge card password, and the corresponding mobile terminal ID, such as a mobile number.

Step 104: The SCP returns a recharge card failure message to the MSC/SSP, notifying the mobile user that the recharging is not allowed.

After receiving the recharge card failure message, the MSC/SSP sends a voice announcement of invalid recharge card to the mobile terminal, prompting the mobile user that the recharge card is invalid for recharging.

Step 105: The SCP sends a request of querying the recharge card state to the VC, with the recharge card password carried in the request.

The VC queries the state of the recharge card according to the recharge card password carried in the request of querying the recharge card state, and returns the obtained recharge card state to the SCP.

Step 106: The SCP judges whether the recharge card is valid, and, if the recharge card is valid, the procedure goes to Step 107, or else Step 110.

Step 107: The SCP deposits a sum corresponding to the par value of the recharge card into the account of the mobile terminal.

Step 108: The SCP sends a request of setting the recharge card state to the VC, with the recharge card password carried in the request.

The VC sets the state of the recharge card to invalid, according to the recharge card password carried in the request of setting the recharge card state, and returns a response message to the SCP, with the setting result carried in the message.

Step 109: If no response message with the setting result of the recharge card is received by SCP within a pre-set time limit, for example, 10 seconds, after the SCP sends the request of setting the recharge card state to the VC, the SCP will record the associated information about recharge card setting failure, and sends a prompt message of successful recharging to the MSC/SSP, instructing the MSC/SSP to play an voice announcement of successful recharging to the mobile user.

After receiving the prompt message of successful recharging, the MSC/SSP plays a voice announcement to the mobile user, indicating success of recharging.

Step 110: The SCP returns a recharge card failure message to the MSC/SSP, notifying the mobile user that the recharging is not allowed.

After receiving the recharge card failure message, the MSC/SSP sends a voice announcement of invalid recharge card to the mobile terminal, prompting the mobile user that the recharge card is invalid for recharging.

In the embodiment, when the mobile user recharges the mobile terminal through the recharge card, the SCP checks for information about unsuccessful setting of the recharge card state corresponding to the mobile terminal according to the obtained recharge card ID, and, if such information exists, returns a recharge card failure message to notify the mobile user that the recharging is not allowed. In the case of unsuccessful setting of the recharge card state, the SCP will record the associated information about unsuccessful setting of the recharge card state, for example, the recharge card password, and the corresponding user number. Therefore, the SCP can identify the recharge card when the mobile user reattempts to recharge through the same recharge card, which prevents one recharge card from recharging the same mobile terminal repeatedly, and ensures one recharge card to recharge successfully only once.

An apparatus for recharging provided in an embodiment of the invention includes: a judging module, adapted to receive a request including a recharge card ID; a response module, adapted to judge whether the recharge card is valid, according to the associated information of received recharge card ID and the mobile terminal ID. The apparatus may be a SCP or a VC and will be described in greater detail below.

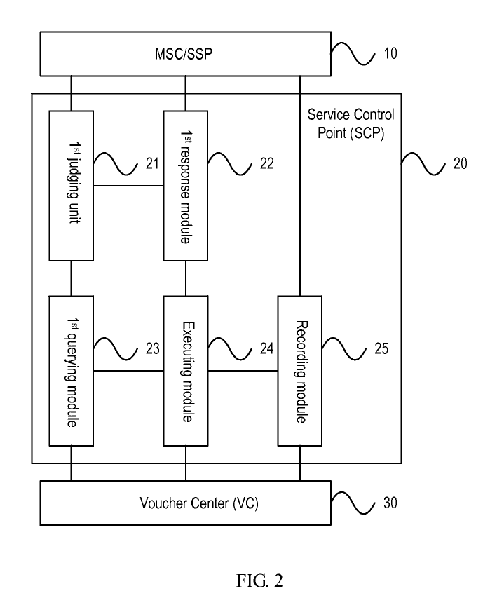

FIG. 2 shows the architecture diagram of a recharging system, according to an embodiment of the invention. The recharging system under this embodiment includes MSC/SSP 10, SCP 20 and VC 30 which are connected sequentially. The SCP 20 is adapted to receive the recharging request message forwarded by MSC/SSP 10 from a mobile terminal; according to received recharge card password, judge whether the information about unsuccessful setting of the recharge card state corresponding to the mobile terminal exists, and, if the information exists, return a recharge card failure message to MSC/SSP 10.

In the embodiment, SCP 20 may include a first judging module 21 and a first response module 22 which are interconnected. The first judging module 21 is connected with MSC/SSP 10, and is adapted to receive the recharging request message forwarded by MSC/SSP 10; according to received recharge card password, judge whether the information about unsuccessful setting of the recharge card state corresponding to the mobile terminal exists. The first response module 22 is connected with MSC/SSP 10, and is adapted to return a recharge card failure message to MSC/SSP 10 when the first judging module 21 determines that the information about unsuccessful setting of the recharge card state corresponding to the mobile terminal exists.

Further, SCP 20 in the embodiment may include a first querying module 23, an executing module 24 and a recording module 25 which are interconnected. The first querying module 23 is connected with the first judging module 21 and VC 30, and is adapted to communicate with VC 30 to obtain the state of the recharge card when the first judging module 21 determines that no information about unsuccessful setting of the recharge card state corresponding to the mobile terminal exists. The executing module 24 is adapted to deposit the sum corresponding to the par value of the recharge card into the user account and send a request of setting the recharge card state to the VC 30 after the first querying module 23 finds out that the state of the recharge card is valid. The recording module 25 is connected with the executing module 24, MSC/SSP 10 and VC 30, respectively, and is adapted to record the associated information about unsuccessful setting of the recharge card state and send a prompt message of successful recharging to MSC/SSP 10, if no response message about the recharge card setting result is received from the VC 30 within a preset time limit after the executing module 24 sends a request of setting the recharge card state to the VC 30.

In the embodiment, when the mobile user recharges for a mobile terminal through a recharge card, the first judging module judges whether the information about unsuccessful setting of the recharge card state corresponding to the mobile terminal exists according to the obtained recharge card ID, and, if the information exists, the first response module returns a recharge card failure message to notify the mobile user that the recharging is not allowed. In the case of unsuccessful setting of the recharge card, the recording module will record the associated information about unsuccessful setting of the recharge card state, for example, the recharge card password, and the corresponding user number. Therefore, the first judging module can identify the recharge card when the mobile user reattempts to recharge through the same recharge card, which prevents one recharge card from recharging the same mobile terminal repeatedly, and ensures one recharge card to recharge successfully only once.

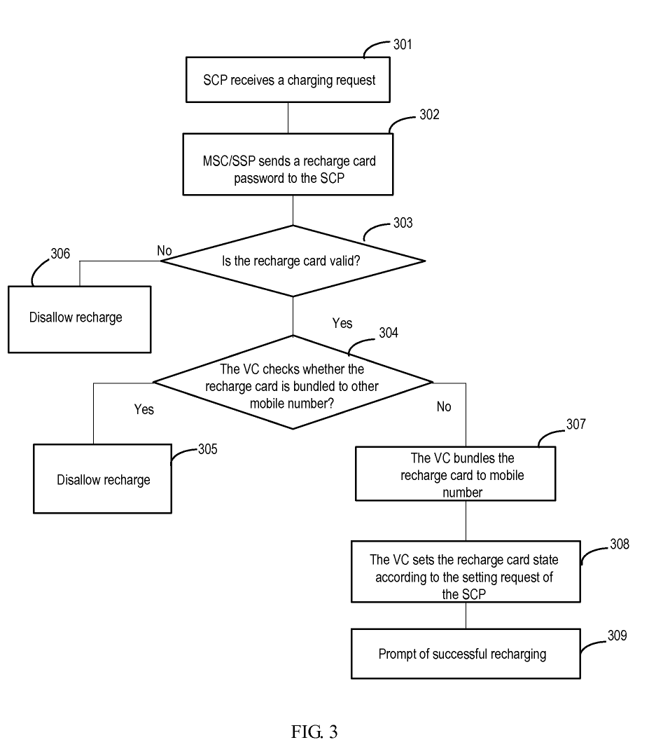

FIG. 3 is the flowchart of another recharging method, according to an embodiment of the invention. This embodiment prevents one recharge card from recharging different mobile numbers repeatedly at the VC side, and includes the steps.

Step 301: The SCP receives a recharging request of a mobile terminal from the MSC/SSP.

A mobile user dials a service access number to originate a call request to the MSC/SSP, and the MSC/SSP triggers the service to the SCP, according to the service access number.

Step 302: The SCP returns to the MSC/SSP a message of playing a voice announcement to the mobile user, to prompt the user to input the recharge card password.

The MSC/SSP plays a voice announcement to the mobile user to obtain the recharge card password, and sends the recharge card password to the SCP.

Step 303: The SCP sends a request of querying the recharge card state to the VC, with the recharge card password carried in the request.

The VC queries the state of the recharge card and checks whether recharge card is valid according to the received recharge card password carried in the request of querying the recharge card state. If the recharge card is valid, the procedure goes to Step 304; or else the procedure goes to Step 306.

Step 304: The VC judges whether the recharge card is associated with another mobile number that is different from the mobile number ID corresponding to the recharge card, namely, whether a number lock is set. If a number lock is set, the procedure goes to Step 305; if not set, the procedure goes to Step 307.

Step 305: The VC returns a response message about the recharge card state to the SCP, indicating that the recharge card is locked.

After receiving the response message indicative of a locked recharge card, the SCP returns a recharge card failure message to the MSC/SSP, notifying the mobile user that the recharging is not allowed.

After receiving the recharge card failure message, the MSC/SSP sends a voice announcement of invalid recharge card to the mobile terminal, prompting the mobile user that the recharge card is invalid for recharging.

Step 306: The VC returns a query result to the SCP, indicating that the recharge card is invalid.

The SCP returns a recharge card failure message to the MSC/SSP according to the previous query result, notifying the mobile user that the recharging is not allowed.

After receiving the recharge card failure message, the MSC/SSP sends a voice announcement of invalid recharge card to the mobile terminal, prompting the mobile user that the recharge card is invalid for recharging.

Step 307: The VC associates the recharge card to the mobile terminal number, namely, sets a number lock, and returns a recharge card state response to the SCP, indicating that the recharge card is valid.

Step 308: After receiving the response message about the recharge card state indicative of a valid recharge card, the SCP sends a request of setting the recharge card state to the VC, with the recharge card password carried in the request.

The VC sets the state of the recharge card to invalid according to the recharge card password carried in the request of setting the recharge card state, and returns a response message to the SCP, with the setting result carried in the message.

Step 309: After receiving the response message about the setting result, the SCP returns a successful recharging prompt to the MSC/SSP, prompting the MSC/SSP to play a voice of successful recharging announcement to the mobile user.

After receiving the prompt message of successful recharging, the MSC/SSP plays a voice announcement to the mobile user, indicating success of recharging.

In the embodiment, when the mobile user recharges the mobile terminal through the recharge card and the recharge card is valid, the VC judges whether the recharge card is associated with another mobile number. If the recharge card is associated with another mobile number, the VC returns a response message about the recharge card state indicating that the recharge card is locked, so as to notify the mobile user that the recharging is not allowed. If not associated, the VC associates the recharge card to the mobile number, so that the VC can identify the recharge card when another mobile user attempts to recharge through the same recharge card, which prevents one recharge card from recharging different mobile terminals repeatedly, and ensures one recharge card to recharge successfully only once.

This method embodiment at the VC side may be performed cooperatively with the method embodiment at the SCP side. The SCP receives a recharging request message of a mobile terminal, and judges whether the information of unsuccessful setting of the recharge card state including the received recharge card ID and the corresponding mobile terminal ID exists: if such information exists, the SCP returns a recharge card failure message; if the information of unsuccessful setting of the recharge card state corresponding to the mobile terminal does not exist, the SCP queries the state of the recharge card at the VC. The VC queries the recharge card state, according to the recharge card ID carried in a request of querying the state of the recharge card from the SCP. If the VC finds out that the state of the recharge card is valid, the VC judges whether the recharge card is associated with a mobile terminal ID different form the mobile terminal ID corresponding to the recharge card: if associated, the VC returns a recharge card state response indicating that the recharge card is invalid; if not associated, the VC associates the recharge card ID to the mobile number, and notifies the SCP to deposit a sum corresponding to the par value of the recharge card into the account of the mobile terminal.

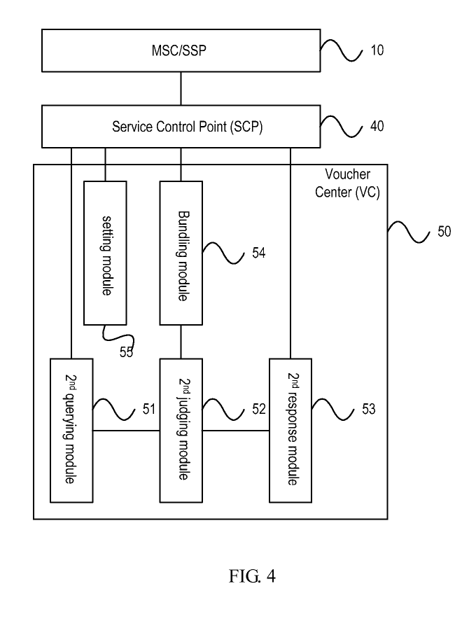

FIG. 4 shows the architecture diagram of another recharging system according to an embodiment of the invention. The recharging system under this embodiment includes MSC/SSP 10, SCP 40 and VC 50 which are connected sequentially. In the recharging system, the VC 50 queries the state of the recharge card according to the recharge card password carried in the request of querying the state of the recharge card of a mobile terminal received from the SCP 40; when the recharge card is valid, the VC 50 judges whether the recharge card is associated with another mobile number; if associated, the VC 50 returns a response message about the recharge card state to the SCP 40, indicating that the recharge card is locked. As an example, the SCP 40 may also be adapted to receive the recharging request message forwarded by MSC/SSP 10 from a mobile terminal; according to the received recharge card password, the information about unsuccessful setting of the recharge card state corresponding to the mobile terminal is checked, and, if the information exists, a recharge card failure message to MSC/SSP 10 is returned.

In the embodiment, the VC 50 may include a second querying module 51, a second judging module 52 and a second response module 53 which are connected sequentially. The second querying module 51 is connected with the SCP 40, and is adapted to query the state of the voucher card according to the voucher card password carried in the request of querying the voucher card state received from the SCP 40. The second judging module 52 is adapted to judge whether the recharge card is associated with another mobile number when the second querying module 51 finds out that the recharge card is valid. The second response module 53 is connected with the SCP 40, and is adapted to return a state response message to the SCP 40 indicating that the recharge card is locked, if the second judging module 52 determines that the recharge card is associated with another mobile number.

Further, the VC 50 in the embodiment may include a associating module 54 and a setting module 55. The associating module 54 is connected with the second judging module 52 and the SCP 40, and is adapted to associate the recharge card to the mobile number when the second judging module 52 determines that the recharge card is not associated with another mobile number, and return a state response message about a valid recharge card to the SCP 40. The setting module 55 is connected with the SCP 40, and is adapted to set the recharge card to the invalid state according to the recharge card password carried in the request of setting the recharge card received from the SCP 40, and return a response message about the setting result to the SCP 40.

In the embodiment, when the mobile user recharges a mobile terminal through a recharge card and the second querying module finds out that the recharge card is valid, the second judging module judges whether the recharge card is associated with another mobile number. If associated, the second response module returns a response message about the recharge card state indicating that the recharge card is locked, so as to disallow the mobile user to recharge. If not associated, the associating module associates the recharge card to the mobile number, so that the second judging module can identify the recharge card when another mobile user attempts to recharge through the same recharge card, which prevents one recharge card from recharging different mobile terminals repeatedly, and ensures one recharge card to recharge successfully only once.

Embodiments within the scope of the present invention also include computer-readable media for carrying or having computer-executable code, computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media, such as RAM, ROM, or other optical disk storage, magnetic disk storage, or other magnetic storage devices, or any other media which can be used to carry or store desired program code means in the form of computer-executable instructions, computer-readable instructions, or data structures and which may be accessed by a general-purpose or special-purpose computer system.

The embodiments as well as the features of such embodiments described above can be combined if they do not exclude each other.

The previous embodiments of this invention are to indicate rather than restrict the technical solution of the present invention. Although detailed description is made for the invention, it is to be understood that those skilled persons in the field can make various modifications and equivalent substitutions to the technical solutions under the previous embodiments of the invention without departing from the scope of this invention.

What is claimed is:

1. A recharging method, comprising:
receiving a request including a recharge card ID; and
judging whether the recharge card is valid, according to information associated with the received recharge card ID and a mobile terminal ID.

2. The recharging method according to claim 1, wherein the request is a recharging request message of a mobile terminal;
the associated information is information of an unsuccessful setting of a state of the recharge card, including the received recharge card ID and the corresponding mobile terminal ID; and
judging whether the recharge card is valid comprises judging whether the associated information exists and, if the associated information exists, returning a recharge card failure message.

3. The recharging method according to claim 2, wherein the method further comprises:
if the associated information does not exist, querying the state of the recharge card;
if the state of the recharge card is valid, depositing a sum corresponding to the par value of the recharge card into the account of the mobile terminal;
sending a request of setting the state of the recharge card; and
if no response message is received for setting the state of the recharge card state is received within a pre-set time limit, recording the associated information of unsuccessful setting of the recharge card state.

4. The recharging method according to claim 1, wherein the request queries a state of the recharge card at a mobile terminal;
the associated information of the received recharge card ID and the mobile terminal ID is the information indicating whether the recharge card is associated with a mobile terminal ID different from the mobile terminal ID corresponding to the recharge card; and
judging whether the recharge card is valid comprises judging whether the information indicates the recharge card is associated with a mobile terminal ID different from the mobile terminal ID corresponding to the recharge card when the state of the recharge card is determined to be valid and, if the information indicates the recharge card is associated with another mobile terminal ID, returning a recharge card state response indicating that the recharge card is invalid.

5. The recharging method according to claim 4, wherein the method further comprises:
if the recharge card is not associated with the different mobile terminal ID, associating the recharge card to the mobile terminal ID, and returning a recharge card state response indicating that the recharge card is valid.

6. The recharging method according to claim 5, wherein the method further comprises:
setting the state of the recharge card to invalid according to the recharge card ID carried in a request of setting the state of the recharge card.

7. An apparatus for recharging, comprising:
a judging module, adapted to receive a request including a recharge card ID; and
a response module, adapted to judge whether a recharge card associated with the recharge card ID is valid according to information associated with the recharge card ID and a mobile terminal ID.

8. The apparatus for recharging according to claim 7, wherein the apparatus is a Service Control Point, SCP, and the SCP comprises:
a first judging module, adapted to receive a recharging request message of a mobile terminal, and judge whether the information of an unsuccessful setting of a state of the recharge card state including the received recharge card ID and the corresponding mobile terminal exists; and
a first response module, adapted to return a recharge card failure message to the mobile terminal when the first judging module determines that the information of the unsuccessful setting of the state of the recharge card state corresponding to the mobile terminal exists.

9. The apparatus for recharging according to claim 8, further comprising:
a first querying module, adapted to communicate with a Voucher Center, VC, to query the state of the recharge card when the first judging module determines that the associated information about unsuccessful setting of the recharge card state corresponding to the mobile terminal does not exist;
a executing module, adapted to deposit a sum corresponding to the par value of the recharge card into the account of the mobile terminal and send a request of setting the state of recharge card to the VC when the first querying module finds out that the state of the recharge card is valid; and
a recording module, adapted to record the associated information of the unsuccessful setting of the recharge card state when no response message with the setting result of the recharge card is received from the VC within a pre-set time limit.

10. The apparatus for recharging according to claim 7, wherein the apparatus is a Voucher Center, VC, and the VC comprises:
a second querying module, adapted to query a recharge card state according to the recharge card ID carried in a request of querying the state of the recharge card of the mobile terminal received from the SCP;
a second judging module, adapted to judge whether the information indicates the recharge card is associated with a mobile terminal ID different form the mobile terminal ID corresponding to the recharge card when the second querying module finds out that the state of the recharge card is valid; and
a second response module, adapted to return a recharge card state response to the SCP indicating that the recharge card is invalid when the second judging module determines that the recharge card is associated with a mobile terminal ID different from the mobile terminal ID corresponding to the recharge card.

11. The apparatus for recharging according to claim 10, further comprising:
a associating module, adapted to associate the recharge card to the mobile number when the second judging module determines that the recharge card is not associated with the different mobile terminal ID associating the recharge card to the mobile terminal ID, and return a recharge card state response to the SCP indicating that the recharge card is valid.

12. The apparatus for recharging according to claim 11, further comprising:
a setting module, adapted to set the state of the recharge card to invalid according to the recharge card ID carried in the request of setting the state of the recharge card received from the SCP.

13. A recharging system, comprising a Mobile Switching Center (MSC)/Service Switching Point (SSP) and a Service Control Point (SCP), wherein:
the SCP receives a recharging request message of a mobile terminal forwarded by the MSC/SSP, according to received recharge card ID, judges whether information of an unsuccessful setting of a state of the recharge card state including the received recharge card ID and the corresponding mobile terminal exists, and, if the information exists, returns a recharge card failure message to the MSC/SSP.

14. The recharging system according to claim 13, further comprising a Voucher Center (VC), wherein:
the VC queries a recharge card state according to a recharge card ID carried in a request of querying the state of the recharge card of a mobile terminal received from the SCP; when the state of the recharge card is valid, the VC judges whether the recharge card is associated with a mobile terminal ID different form the mobile terminal ID corresponding to the recharge card, and, if associated, the VC returns a recharge card state response indicating that the recharge card is invalid.

15. The recharging system according to claim 14, wherein if the recharge card is not associated with a mobile terminal ID different form the mobile terminal ID corresponding to the recharge card, the VC associates the recharge card to the mobile number, and returns a recharge card state response to the SCP indicating that the recharge card is valid.

16. A recharging method, comprising:
receiving a recharging request message of a mobile terminal by a SCP;
judging whether an associated information of an unsuccessful setting of the recharge card state including the received recharge card ID and the corresponding mobile terminal ID exists;
if the information exists, returning a recharge card failure message;
if the associated information of unsuccessful setting of the recharge card state corresponding to the mobile terminal does not exist, querying the state of the recharge card at a VC;
querying the recharge card state, by the VC, according to the recharge card ID carried in a request of querying the state of the recharge card from the SCP;
judging whether the recharge card is associated with a mobile terminal ID different form the mobile terminal ID corresponding to the recharge card when the state of the recharge card is valid; and
if associated, returning a recharge card state response indicating that the recharge card is invalid.
